(19) United States
(12) Patent Application Publication
(10) Pub. No.: US 2007/0189716 A1
(43) Pub. Date: Aug. 16, 2007

(54) Disk device, control circuit, disk controlling method, and command controlling method

(75) Inventor: Takeshi Tanaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/408,710

(22) Filed: Apr. 21, 2006

(30) Foreign Application Priority Data
Jan. 18, 2006 (JP) 2006-010475

(51) Int. Cl. H04N 7/00

(52) U.S. Cl. 386/95

(57) ABSTRACT

A multiplexing specification command that includes information indicative of a method of multiplexing and a degree of multiplexing is stored in a command register. Multiplexing of data is performed based on the method of multiplexing and the degree of multiplexing set in the multiplexing specification command. The method of multiplexing can be sector multiplexing, head multiplexing, platter multiplexing, and cylinder multiplexing.

### BACKGROUND OF THE INVENTION

1. Field of the Invention

The present invention generally relates to a technology for multiplexing data and recording the multiplexed data in a disk device. The present invention specifically relates to a technology for setting the method and degree of multiplexing.

2. Description of the Related Art

Recently, to improve reliability of data recorded in a magnetic disk device, a method of Redundant Arrays of Inexpensive Disks (RAID) that includes multiplexing data and recording the multiplexed data has been widely used. However, RAID requires a plurality of magnetic disk devices, which leads to increased cost and space occupancy.

One approach is to multiplex data and record the multiplexed data in a single magnetic disk device. Japanese Patent Publication No. 2000-099279, for example, discloses such an approach.

However, in the technology described in Japanese Patent Publication No. 2000-099279, the method of multiplexing is limited to a method of head multiplexing, namely, using different heads corresponding to each location of recording on a single cylinder. Moreover, the degree of multiplexing is also fixed at the time of initialization, so that the degree of multiplexing cannot be changed initialization is performed.

### SUMMARY OF THE INVENTION

It is an object of the present invention to at least partially solve the problems in the conventional technology.

According to an aspect of the present invention, a disk device that records data in a disk medium at a plurality of locations in a multiplexed manner, includes a receiving unit that receives write-method information indicative of a method of multiplexing and degree information indicative of a degree of multiplexing; and a multiplexed write unit that writes data in the disk medium in a multiplexed manner based on the write-method information and the degree information received by the receiving unit.

According to another aspect of the present invention, a disk control method of controlling a disk medium that records therein data in at a plurality of locations in a multiplexed manner, includes receiving write-method information indicative of a method of multiplexing and degree information indicative of a degree of multiplexing; and writing data in the disk medium in a multiplexed manner based on the write-method information and the degree information received at the receiving.

According to still another aspect of the present invention, a command controlling method of issuing a prespecified command to the disk device to control the disk device, includes issuing a write-command for writing data on a disk medium of the disk device; issuing a multiplexing command that includes write-method information indicative of a method of multiplexing and degree information indicative of a degree of multiplexing; and writing data in the disk medium in a multiplexed manner, when receiving the write command and the multiplexing command, based on the write-method information and the degree information in the multiplexing command.

According to still another aspect of the present invention, a computer-readable recording medium stores therein a computer program that causes a computer to implement the above method.

According to still another aspect of the present invention, a control circuit that records data in a disk medium at a plurality of locations in a multiplexed manner, includes a receiving unit that receives write-method information indicative of a method of multiplexing and degree information indicative of a degree of multiplexing; and a multiplexed write unit that writes data in the disk medium in a multiplexed manner based on the write-method information and the degree information received by the receiving unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts a hardware configuration of a magnetic disk device according to an embodiment of the present invention;

FIG. 2 is a detailed functional block diagram of a read/write controller shown in FIG. 1;

FIG. 3A is an example of the format of a multiplexing specification command;

FIG. 3B is an example of values stored in a command register shown in FIG. 2 upon receipt of the multiplexing specification command;

FIG. 4 is a schematic for explaining an example of the data structure of a multiplexing controlling table;

FIG. 5 is an example of the format of a read specification command;

FIG. 6 is a flowchart of a processing procedure of multiplexing specification executed by a multiplexing manager shown in FIG. 2 upon receipt of the multiplexing specification command;

FIG. 7 is a flowchart of a processing procedure of data write executed by the read/write controller;

FIG. 8 is a flowchart of a processing procedure of reporting location of data write executed by the multiplexing manager; and

FIG. 9 is a flowchart of a processing procedure of data read executed by the read/write controller.

### DETAILED DESCRIPTION OF THE PREFERRED EMBODIMENTS

Exemplary embodiments of the present invention will be explained below in detail while referring to the accompanying drawings.

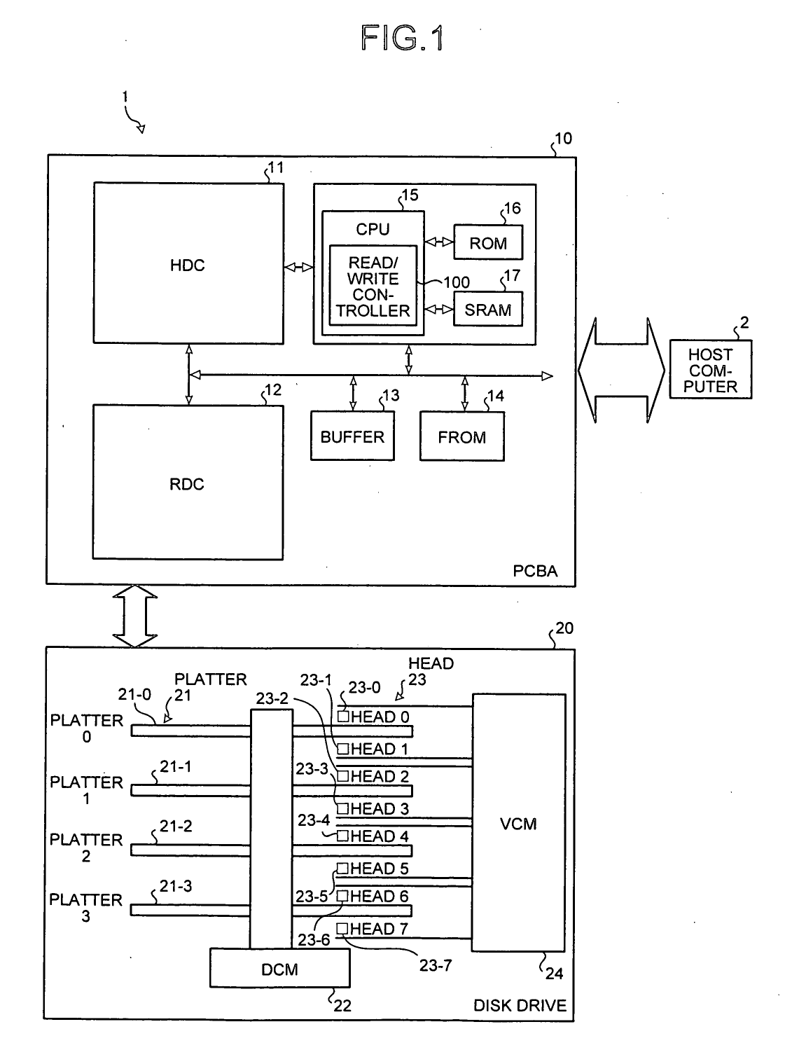

At first, the configuration of a magnetic disk device according to an embodiment of the present invention is explained. FIG. 1 depicts a hardware configuration of a magnetic disk device 1 according to the embodiment. The magnetic disk device 1 includes a printed circuit board assembly (PCBA) 10 and a disk drive 20. The magnetic disk device 1 is connected to a host computer 2 via an ATA interface (not shown). Thus, data, control command, and the like can be exchanged between the magnetic disk device 1 and the host computer 2.

Various LSI's are arranged on the PCBA 10, which is a printed circuit board, and those LSI's are used to control the magnetic disk device 1. The PCBA 10 includes a hard disk controller (HDC) 11, a read channel (RDC) 12, a buffer 13, a fast read-only memory (FROM) 14, a central processing unit (CPU) 15, a read-only memory (ROM) 16, and a static random access memory (SRAM) 17, each of which are mutually connected via a bus.

The HDC 11 is a controller that controls an operation of writing data present in the buffer 13 on the disk drive 20 and an operation of reading the data from the disk drive 20 and storing the same in the buffer 13. The RDC 12 is an LSI that mediates between the buffer 13 and the disk drive 20 to modulate or demodulate data.

The buffer 13 is a cache that temporarily stores the data transacted between the host computer 2 and the disk drive 20. The FROM 14 is a nonvolatile memory that stores the firmware that controls the operation of the magnetic disk device 1. The firmware is read and developed in the SRAM 17 before its execution.

The CPU 15 is a central processor that executes the firmware developed in the SRAM 17. A part of the firmware is executed within the CPU 15 as a read/write controller 100.

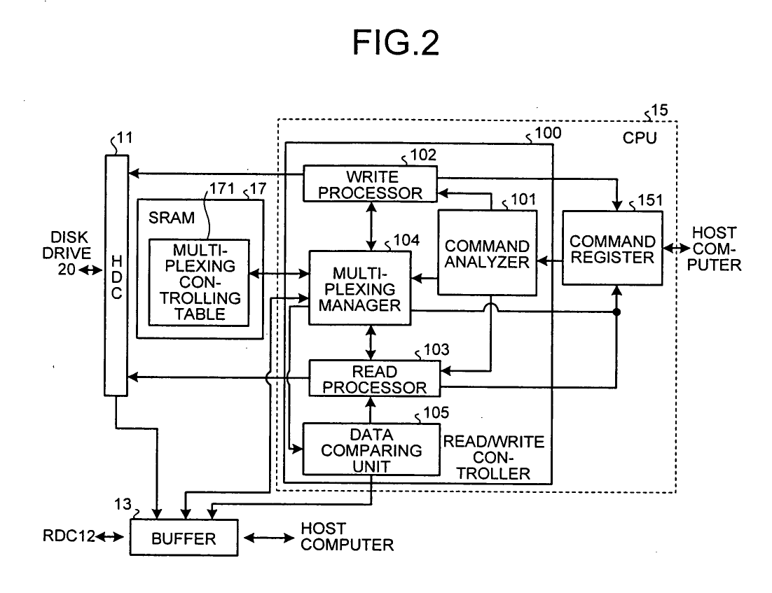

The ROM 16 is a nonvolatile memory that stores therein various parameters required for operating the magnetic disk device 1. The SRAM 17 is a volatile memory used to develop the firmware stored in the FROM 14. The SRAM 17 stores information, such as the locations of the recorded data when the data is multiplexed and recorded, in a multiplexing controlling table 171 (refer to FIG. 2).

The disk drive 20 is a storage unit where data is recorded, and includes four platters 21 (platters 21-0 to 21-3), a direct-current motor, (DCM) 22, eight heads 23 (heads 23-0 to 23-7), and a voice-coil motor (VCM) 24.

Each platter 21 is a disk-shaped substrate having two magnetic recording surfaces, i.e., on both top and bottom sides, and also referred to as a magnetic disk medium. The DCM 22 is a driving unit that rotates the platters 21. Each head 23 is a magnetic head that magnetically reads/writes data on a magnetic recording surface of the platter 21. The VCM 24 is a driving unit that moves the head 23 to a desired location of data read/write by moving the head 23 in the radial direction of the disk.

The read/write controller 100 specifies and controls the HDC 11 to execute data write and data read based on the setup related to the multiplexing specified by the host computer 2. The host computer 2 is an upper level device. and can be a personal computer. The magnetic disk device 1 can perform multiplexing and recording of data by four methods of head multiplexing, platter multiplexing, sector multiplexing, and cylinder multiplexing. A user can select a desirable multiplexing method out of the four multiplexing methods.

Each of the multiplexing methods is explained in detail here. The head multiplexing is a method of writing the same data at different positions by using different heads. In the head multiplexing, one head is used to write data at one location.

The platter multiplexing is a method of writing the same data on different platters. In the platter multiplexing, one platter has one writing location. In both the head multiplexing and the platter multiplexing, it is sufficient that the data is written on different head or different platter, respectively, namely, there is no limitation on how a cylinder or a sector is specified,

The sector multiplexing is a method of writing the same data in the same track on different sectors of the same cylinder. In the sector multiplexing, the same head writes the same data a plurality of times.

The cylinder multiplexing is a method of writing the same data on different cylinders. In the cylinder multiplexing, it is sufficient that the cylinder is different, namely, there is no limitation on how a head, a platter, and a sector are specified.

Because a user can select a desired multiplexing method, the usability of the device increases.

The multiplexing command issued by the host computer 2 is newly established as a protocol in an interface program of the host computer 2 to achieve the present invention.

Next, the configuration of the read/write controller 100 is explained. FIG. 2 is a detailed functional block diagram of the read/write controller 100. The CPU 15 includes a command register 151.

The command register 151 is a register that stores therein a control command that the host computer 2 issues to the magnetic disk device 1. Among the control commands stored in the command register 151 the control command related to the data multiplexing includes a multiplexing specification command that specifies a method of multiplexing and a read specification command that specifies the location of reading the multiplexed data. The read/write controller 100 reads the control command stored in the command register 151, and performs a processing corresponding to the read control command.

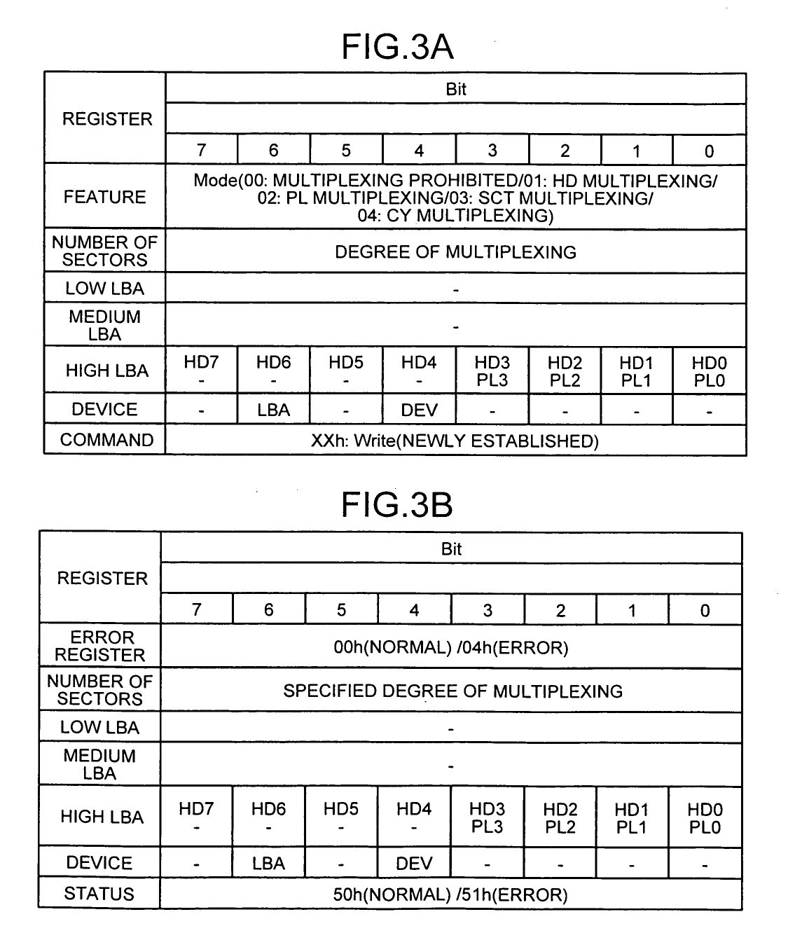

FIG. 3A is an example of the format of the multiplexing specification command. the multiplexing specification command uses four rows of a feature, number of sectors, high LBA, and a command in the command register 151. The command at the bottommost row specifies the type of the control command, and a value corresponding to the multiplexing specification command is set here.

The feature specifies the multiplexing method. As the value of the feature, “01” is set for the head multiplexing (HD multiplexing), “02” is set for the platter multiplexing (PL multiplexing), “03” is set for the sector multiplexing (SCT multiplexing), and “04” is set for the cylinder multiplexing (CY multiplexing). To prohibit multiplexing, “00” is set in the feature.

The number of the sector specifies the degree of multiplexing. For instance, when the number of the sector is “03”, the data is to be written in triplicate.

The high LBA specifies the head/platter used for writing the multiplexed data. The head number corresponding to the write location is specified in the high LBA when the multiplexing method is the head multiplexing, and the platter number corresponding to the write location is specified in the high LBA when the multiplexing method is the platter multiplexing. For instance, when the head multiplexing is specified as the multiplexing method and three heads of a zeroth head “HD0”, a first head “HD1”, and a second head “HD2” as the locations of data write, a value calculated assuming the corresponding zeroth bit, first bit, and third bit as one and other bits as zero, namely “07”, is set as the value of the high LBA.

Also, when the read/write controller 100 receives a control command such as the multiplexing specification command, a value corresponding to the current status is returned to the command register 151. FIG. 3B is example of values stored in the command register 151 upon receipt of the multiplexing specification command. Each value, indicated in the figure corresponds to the format of the multiplexing specification command shown in FIG. 3A, but the top row is used as an error register instead of the feature, and the bottom row is used as the status instead of the command.

Information is set in the error register is used to decides whether the read/write controller 100 correctly recognized the multiplexing command. When “00 h” is present in the error register it means that the control command is correctly recognized, and when “04 h” is set in the error register it means that the control command is not correctly recognized, i.e., an error has occurred.

Also, information set in the status is used to decide the status returned by the read/write controller 100. For instance, when the status is “D0 h (busy)” it means a busy status, “58 h (request for data)” causing an interruption to exchange data with the host computer 2, and “50 h (drive ready)” requesting a next control command from the host computer 2 after the normal completion of the processing.

Among other control commands stored in the command register 151, the write command for data write and the read command for data each specifies the start address of the location of data read based on the LBA method and the data size. The read specification command will be explained in detail later.

The read/write controller 100 controls data read and data write in the magnetic disk device 1. The read/write controller 100 includes a command analyzer 101, a write processor 102, a read processor 103, a multiplexing manager 104, and a data comparing unit 105.

The command analyzer 101 is a processing section that analyzes the type of the control command stored in the command register 151 and sorts the control command. The command analyzer 101 sorts the control command to the write processor 102 if the control command is a write command, to the read processor 103 if the control command is a read command, or to the multiplexing manager 104 if the control command is a multiplexing specification command or a read specification command. The command analyzer 101 identifies the type of the control command by referring to value of command (see FIG. 3A) in the command register 151.

The write processor 102 is a processing section that commands the HDC 11 to write the data on the disk drive 20. Upon receipt of a write command from the command analyzer 101, the write processor 102 commands the HDC 11 to write the data stored in the buffer 13 into the location of data write specified by the multiplexing manager 104.

The read processor 103 is a processing section that orders the HDC 11 to read the data from the disk drive 20. Upon receipt of a read command from the command analyzer 101, the read processor 103 commands the HDC 11 to read the data from the location of data read specified by the multiplexing manager 104 and store the same in the buffer 13.

The multiplexing manager 104 is a processing section that decides each location of data read/write for executing multiplexed read/write of the data and manages locations of recording data for the multiplexed data. Upon receipt of a multiplexing specification command from the command analyzer 101, the multiplexing manager 104 extracts setup of the multiplexed write including the multiplexing method, the number of multiplexing, specification of the head/platter from the multiplexing specification command, and stores the setup. The multiplexing manager 104 then decides each location of data write based on the setup related to multiplexing in the following step and passes a plurality of locations of recording data indicating the location of data write to the read processor 103, whereby the data is multiplexedly written.

The multiplexing manager 104 then has the SRAM 17 record such information as the location of recording data for the multiplexed data, and manages the same as the multiplexing controlling table 171. The multiplexing controlling table 171 is recorded in a system area of the disk drive while the magnetic disk device 1 is shut down, and read from the disk drive 20 and stored in the SRAM 17 at the time of start-up.

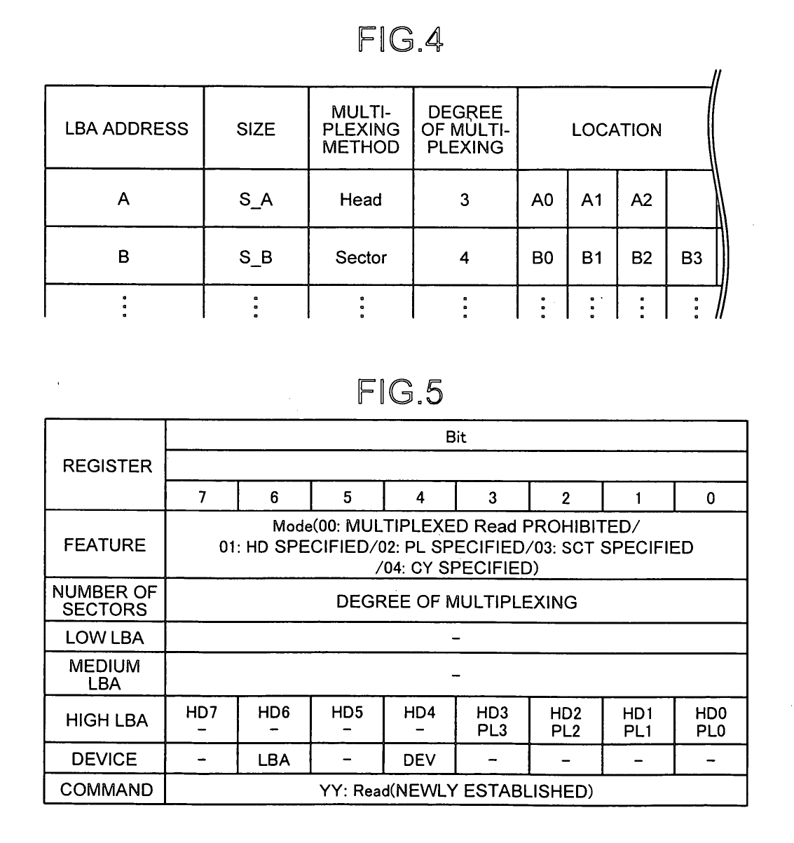

FIG. 4 is an example of the multiplexing controlling table 171. The multiplexing controlling table 171 includes an LBA address starting to specify host computer, size of the data, multiplexing method, degree of multiplexing, and all locations of recording data where the data is written. Among them, the location specifies a data-recording start address by the CHS format. For instance, the data having “A” as the LBA address indicate that the size is “S_A”, the data is in triplicate, and the data are recorded in the locations “A0”, “A1”, and “A2”.

When the data is not multiplexed but written in only one location of data write, the information is also added to the multiplexing controlling table 171. Casein other words, when the degree of multiplexing is “1”, the locations is will be one, and there will be no value in the multiplexing method in the multiplexing controlling table 171.

Also, at the time of data read, with reference to the multiplexing controlling table 171, the multiplexing manager 104 passes all the locations of recording data that indicates all the locations of data read corresponding to the start LBA address specified by the host computer 2 to the read processor 103, and has the data multiplexedly read. For instance, when the read/write controller 100 receives a read command that reads the data of the LBA address starting to specify host computer “A” from the host computer 2, the multiplexing manager 104 reports the three corresponding locations of recording data “A0”, “A1”, and “A2” to the read processor 103 with reference to the multiplexing controlling table 171.

The data comparing unit 105 is a processing section that compares all the read data when the multiplexed data is stored in the buffer 13. As a result of comparison by the data comparing unit 105, only when all the read data agree, the data comparing unit 105 transfers the data to the host computer 2 via the read processor 103.

In this way, since the multiplexing manager 104 manages the location of data write determined based on the setup related to multiplexing as the multiplexing controlling table 171 at the time of multiplexed write and has the read processor 103 read the multiplexed data based on the multiplexing controlling table 171 at the time of data read, and the data comparing unit 105 compares these data, it is possible to easily detect a data error when the multiplexed read is executed, and to improve reliability of the data recorded in the magnetic disk device 1.

Also, when the data comparing unit 105 detects disagreement of the data and the like, the host computer 2 can issue a read specification command to individually specify each of the locations of data read among the multiplexedly written data. At this time, the read specification command issued by the host computer 2 is stored in the command register 151.

FIG. 5 is an example of the format of a read specification command. As shown in the figure, the read specification command uses four rows of the feature, the number of sectors, the high LBA, and the command in the command register 151, and is issued by the host computer and stored in the command register 151 like the multiplexing specification command and the like. Here, a value corresponding to the read specification command is set at the command indicated in the bottom row.

The feature shown in the top row specifies the read method. The value of the feature corresponds to the multiplexing specification command shown in FIG. 3A, namely “01” is set for a read method that specifies the head for the data multiplexed by the head multiplexing, “02” is set for a read method that specifies the platter for the data multiplexed by the platter multiplexing, “03” is set for a read method that specifies the sector for the data multiplexed by the sector multiplexing, and “04” is set for a read method that specifies the cylinder for the data multiplexed by the cylinder multiplexing.

Also, in order to prohibit multiplexed read and terminate data read at the point of reading only one layer of the multiplexed data, “00” is set as the feature. In this case, multiplexed data is prohibited in the data read processings subsequently executed, and the read processor 103 reads the data from other multiplexed and recorded locations of recording data only when a read error occurs. Also, when the prohibition of multiplexed read is specified, data comparison by the data comparing unit 105 is omitted.

The number of sector shown in the second top row specifies a multiplexing number indicating what number of data from the left among a plurality of locations of recording data shown in FIG. 4. The high LBA shown in the fifth top row specifies the head/platter used for read specification by the same method as the multiplexing specification command shown in FIG. 3A.

Then, upon receipt of the read specification command from the command analyzer 101, the multiplexing manager 104 extracts setup including the read method, the degree of multiplexing, and specification of the head/platter from the multiplexing specification command, and stores the setup. The multiplexing manager 104 then decides one location of data read based on the setup in the following data read processing and reports the same to the read processor 103.

In this way, since the read processor 103 limits to only one location of data read among the multiplexedly written data based on the read specification command issued by the host computer 2, it is possible to select an appropriate data based on the user's decision in case of a data error.

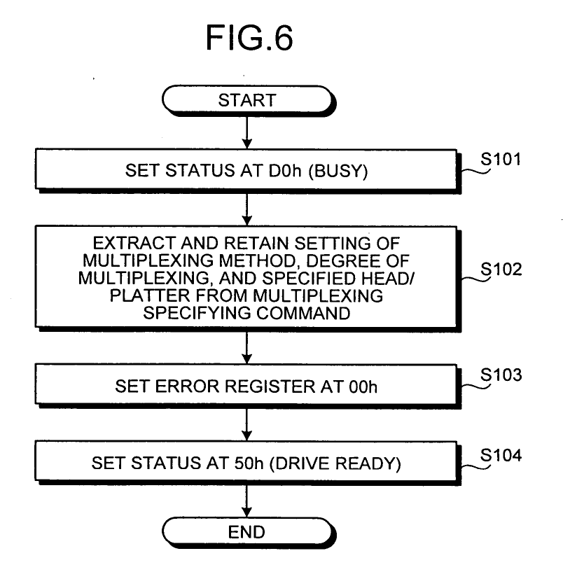

Next, a processing procedure of data write in the magnetic disk device 1 according to the present embodiment is explained. FIG. 6 is a flowchart of a processing procedure of multiplexing specification executed by the multiplexing manager 104 upon receipt of the multiplexing specification command. As shown in the figure, upon receipt of the multiplexing specification command from the command analyzer 101, the multiplexing manager 104 sets the status value of the command register 151 at “D0 h (busy)” to create the busy status. (step S101).

The multiplexing manager 104 then extracts the setup including the multiplexing method, the degree of multiplexing, and the specified head/platter from the multiplexing specification command stored in the command register 151 via the command analyzer 101, and stores the set up (step S102). Subsequent write commands are then multiplexedly written based on each setup related to the multiplication.

After that, the multiplexing manager 104 sets the error register of the command register 151 at “00 h” to report that the multiplexing specification command was correctly identified (step S103), and further sets the status at “50 h (drive ready)” to request the next control command from the host computer 2 (step S104).

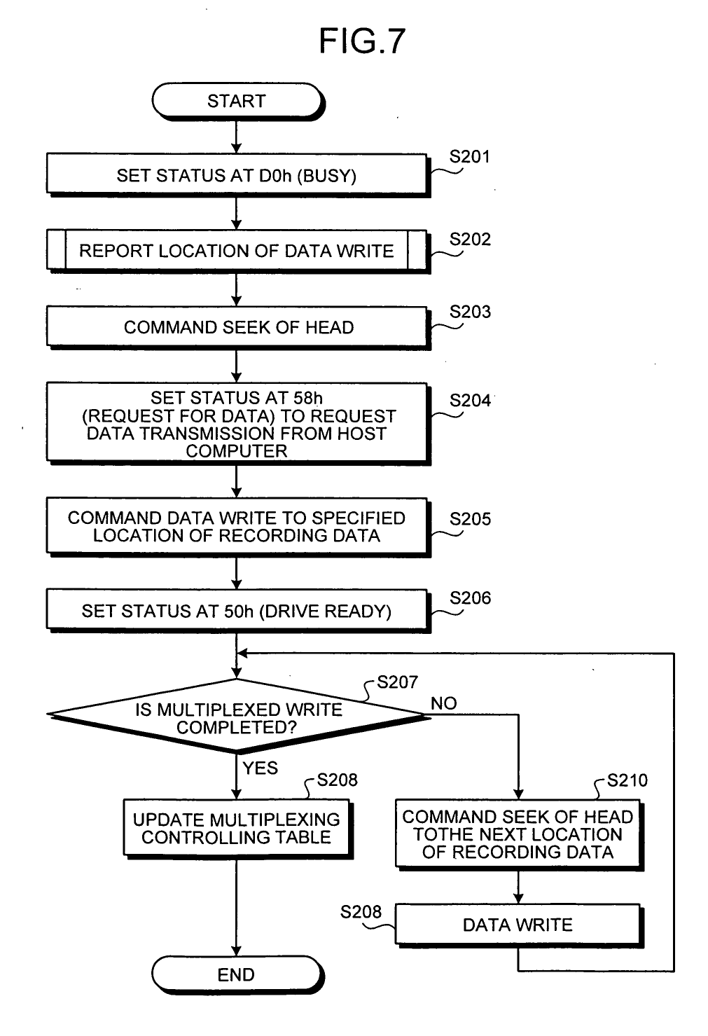

Next, a processing procedure of data write executed by the read/write controller 100 is explained. FIG. 7 is a flowchart of a processing procedure of data write executed by the read/write controller 100. As shown in the figure, upon receipt of a write command from the command analyzer 101, the write processor 102 in the read/write controller 100 sets the status value of the command register 151 at “D0 h (busy)” to create the busy status (step S201).

The multiplexing manager 104 then decides the location of data write based on the presence of setup related to multiplexing and contents of the setup, and reports the location of recording data indicating the location of data write to the write processor 102 (step S202). Here, the number of locations of recording data that the multiplexing manager 104 reports to the write processor 102 is plural when the multiplexed write is executed, and only one when the multiplexed write is not executed. Details of the processing in the step S202 will be described later.

After the location of data write is decided, the write processor 102 commands the HDC 11 to seek the head to the location of recording data reported from the multiplexing manager 104 (step S203). However, when the multiplexing manager 104 reports a plurality of locations of recording data as the locations of data write, seek of the head for the location of recording data reported at first is commanded.

And when preparation for writing data is completed, the write processor 102 sets the status of the command register 151 at “58 h (request for data)” to generate an interruption and requests for data transfer from the host computer 2 (step S204).

When the host computer 2 transfers the data to the magnetic disk device 1 in response to the request for transfer and the data is stored in the buffer 13, the write processor 102 commands the HDC 11 to write the data to the location of recording data specified by the multiplexing manager 104 (step S205), and when writing data completes normally, the write processor 102 sets the status of the command register 151 at “50 h (drive ready)” (step S206). Namely, the write processor 102, regardless of multiplexedly writing or not, requests the next control command from the host computer 2 once writing data is successful, whereby making it possible to receive the next control command immediately.

After that, the write processor 102 judges whether writing data to all the locations of data write are completed (step S207), if the multiplexed write is not yet completed, commands the HDC 11 to seek the head to the location of recording data to write the next data (step S208), and writes a data identical to the data written in step S205 to the location of recording data (step S209). Then, upon completion of data write, return to. step S207 again and repeat the processing of steps S207 to S209.

And when writing data to all the locations of data write is completed, the multiplexing manager 104 associates the LBA address starting to specify host computer, the size, the multiplexing method, the degree of multiplexing, and the location of recording data related to the data to add to the multiplexing controlling table 171 (step S210), and terminates data write.

In this way, since the write processor 102 requests the next control command from the host computer 2 at the point the data write succeeds once no matter multiplexed write is executed or not, it is possible to avoid delay of processing accompanying execution of multiplexed write.

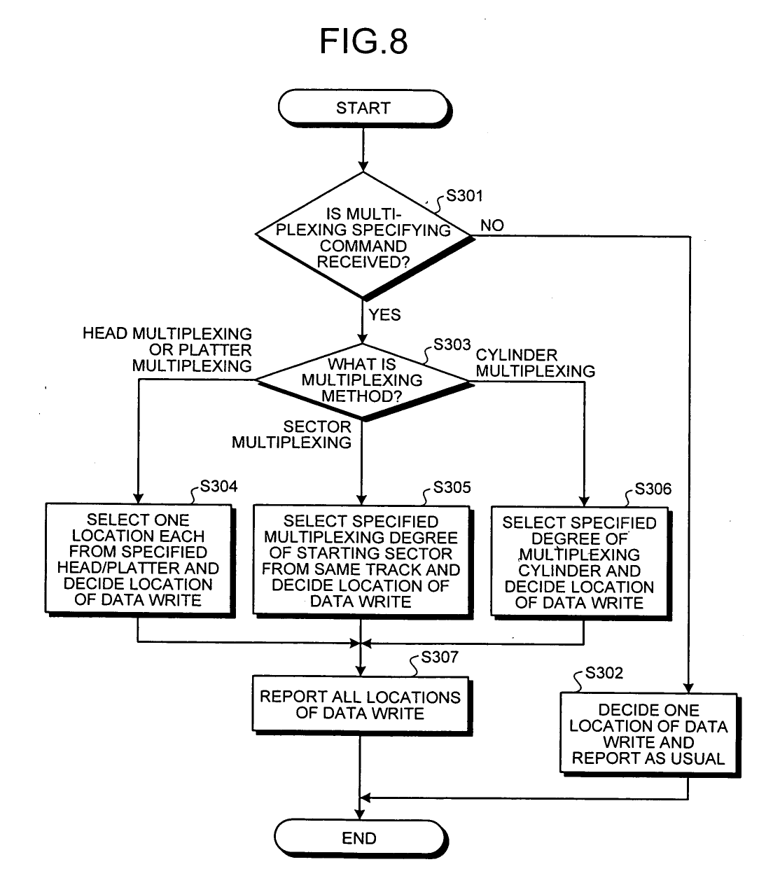

Next, a processing procedure of reporting a location of data write executed by the multiplexing manager 104 during step S202 in FIG. 7 is explained. FIG. 8 is a flowchart of the processing procedure of reporting location of data write executed by the multiplexing manager 104. As shown in the figure, the multiplexing manager 104 decides whether a multiplexing specification command has been received from the host computer (step S301). More specifically, the multiplexing specification processing shown in FIG. 6 is executed, and the multiplexing manager 104 judges whether the multiplexing manager 104 stores the setup related to multiplexing or not.

As a result, if the multiplexing specification command is not received, the multiplexing manager 104 decides one location of data write based on the normal deciding method, and reports the location of recording data indicting the location of data write to the write processor 102 (step S302).

On the other hand, if the multiplexing specification command is already received, the multiplexing manager 104 decides what multiplexing method is specified by the multiplexing specification command (step S303).

Here, when the specified multiplexing method is the head multiplexing, the multiplexing manager 104 selects one location of recording data from each of the heads specified by the multiplexing specification command to decide the location of data write. When the specified multiplexing method is the platter multiplexing, the multiplexing manager 104 also selects one location of recording data from each of the platters specified by the multiplexing specification command to decide the location of data write (step S304).

When the specified multiplexing method is only the sector multiplexing, the multiplexing manager 104 selects the number of start sectors of locations of recording data equal to the degree of multiplexing specified by the multiplexing specification command to decide the location of data write (step S305).

Also, when the specified multiplexing method is the cylinder multiplexing, the multiplexing manager 104 selects the number of cylinders equal to the degree of multiplexing specified by the multiplexing specification command and selects one location of recording data from each of the cylinders to decide the location of data write (step S306).

The multiplexing manager 104 then reports the location of recording data indicating all the locations of data write decided in any one of steps S304 to S306 (step S307) to terminate reporting location of data write.

A first concrete example of the head multiplexing will be explained below. With reference to FIGS. 4 and 8, two examples of deciding each location of data write for multiplexed write are explained here. For instance, when the head multiplexing is specified as the multiplexing method and the data is triplicated to be written using three heads of “HD0”, “HD1”, and “HD2”, “01” indicating the head multiplexing is set as the feature, “03” indicating triplicity is set as the number of sector, “07” indicating “HD0”, “HD1”, and “HD2” is set as the high LBA, and these settings are stored in the multiplexing manager 104.

When the write command specifies “A” for the LBA address starting to specify host computer, in step S304 shown in FIG. 8, the multiplexing manager 104 decides that the location of recording data corresponding to the zeroth head “HD0” is “A0”, the location of recording data corresponding to the first head “HD1” is “A1”, and the location of recording data corresponding to the second head “HD2” is “A2” to report the three locations of recording data to the write processor 102 as the locations of data write. This allows the write processor 102 to execute multiplexed write in triplicity by writing the same data using the three heads “HD0”, “HD1”, and “HD2”.

A second concrete example of the head multiplexing will be explained below. For instance, when the sector multiplexing is specified as the multiplexing method and the data is quadruplicated to be written, “03” indicating the sector multiplexing is set as the feature, “04” indicating quadruplicity is set as the number of sector, and these settings are stored in the multiplexing manager 104. When the sector multiplexing is specified, the value of the high LBA is ignored.

When the write command specifies “B” for the LBA address starting to specify host computer, in step S305 shown in FIG. 8, the multiplexing manager 104 decides four locations of recording data “B0” to “B3” from the tracks corresponding to the LBA address starting to specify host computer specified by the host computer 02 to report the four locations of recording data to the write processor 102 as the locations of data write. This allows the write processor 102 to execute multiplexed write in quadruplicity by writing the data four times in a row on the same track.

In the case of the sector multiplexing, since the same data is written on the same track, seek of the head in the radial direction of the disk does not occur. Also, in the case of the sector multiplexing, since multiplexed write is executed using the same head, switching the head used for writing data does not occur either. Therefore, the time required for multiplexed write by the sector multiplexing is shorter than the time required for the platter multiplexing that differentiates the platters for each location of data write, the head multiplexing that differentiates the heads used for writing the data, and the cylinder multiplexing.

Since multiplexed write is executed on the same track when the sector multiplexing is specified in this way, it is possible to reduce the time required for multiplexed write of the data and to avoid delay of data write accompanying multiplexing.

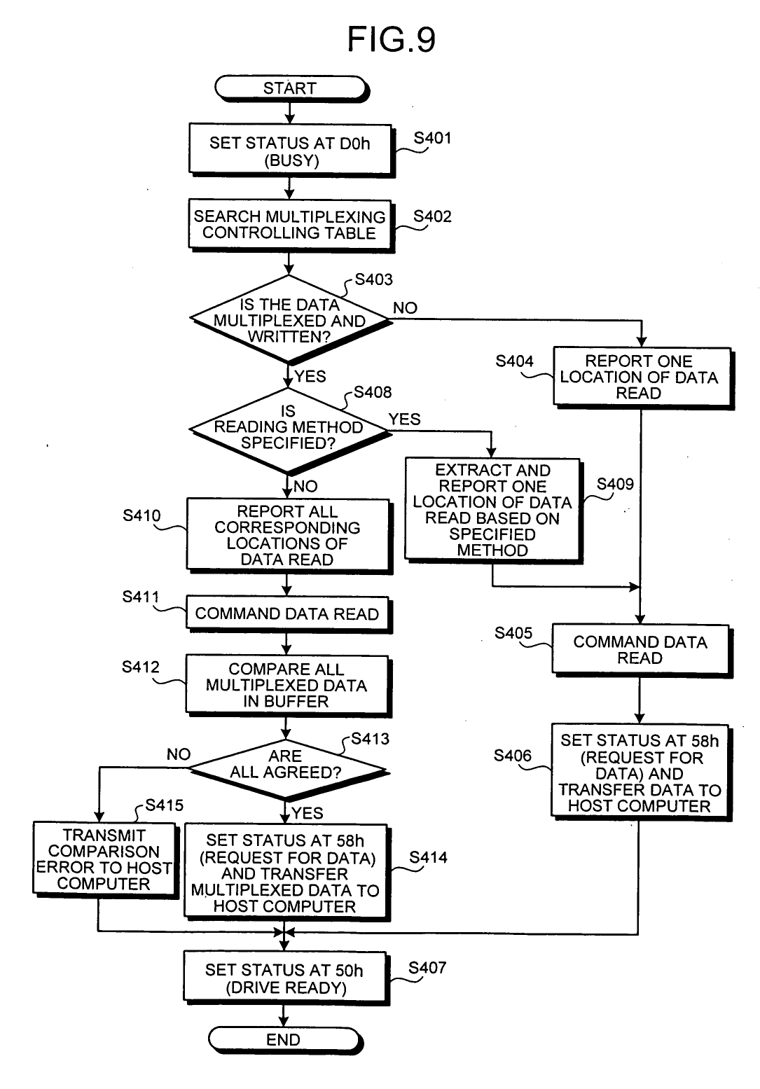

Next, a processing procedure of data read executed by the read/write controller 100. FIG. 9 is a flowchart of a processing procedure of data read executed by the read/write controller 100. As shown in the figure, upon receipt of a read command from the command analyzer 101, the read processor 103 in the read/write controller 100 sets the status value of the command register 151 at “D0 h (busy)” to create the busy status (step S401).

The multiplexing manager 104 then searches the multiplexing controlling table 171 (step S402), and decides whether the data recorded in the location of recording data corresponding to the LBA address starting to specify host computer is multiplexed (step S403). Namely, the multiplexing manager 104 decides whether the degree of multiplexing is “1” in the multiplexing controlling table 171.

When the degree of multiplexing is “1”, the multiplexing manager 104 reports the only location of recording data to the read processor 103 as the location of data read (step S404). The read processor 103 then commands the HDC 11 to read the data from the only location of recording data and store the data in the buffer 13 (step S405).

After that, when the read data is stored in the buffer 13, the read processor 103 sets the status of the command register 151 at “58 h (request for data)”, causes an interruption to transfer the data to the host computer 2 (step S406), and when the data transfer is completed, sets the status of the command register 151 at “50 h (drive ready)” to terminate the data read processing.

On the other hand, when the degree of multiplexing is not “1”, namely when the data to be read is multiplexed, the multiplexing manager 104 further decides whether the read method is specified (step S408). Namely, the multiplexing manager 104 decides whether the read specification command is received via the command analyzer 101 in advance.

As a result, when the multiplexing manager 104 has received the read specification command in advance, the multiplexing manager 104 extracts one location of recording data corresponding to the location of data read specification number specified by the read specification command from the multiplexing controlling table 171, and reports the location of recording data to the read processor 103 as the location of data read (step S409). The read processor 103 then executes the processings of steps S405 to S407 described above and transfers the data from the specified location of data read to the host computer 2 to terminate the data read processing.

On the other hand, when the multiplexing manager 104 has not received the read specification command in advance, the read/write controller 100 has the HDC 11 multiplexedly read the data. Namely, the multiplexing manager 104 decides all locations of recording data corresponding to the LBA address starting to specify host computer with reference to the multiplexing controlling table 171, and reports the locations of recording data to the read processor 103 as the location of data read (step S410). The read processor 103 then commands the HDC 11 to read the data from all the locations of recording data reported from the multiplexing manager 104 and store the data in the buffer 13 (step S411).

When the data are read from all the locations of data read and stored in the buffer 13, the data comparing unit 105 compares all the data (step S412) and decides whether the data all agree (step S413).

Here, when all the multiplexedly read data agree, the read processor 103 sets the status of the command register 151, at “58 h (request for data)”, commands the HDC 11 to transfer only one layer of the data to the host computer 2 (step S414), and when the data transfer is completed, sets the status of the command register 151 at “50 h (drive ready)” (step S407) to terminate the data read processing.

On the other hand, when there is any disagreement of the multiplexedly read data, the read processor 103 reports a comparison error to the host computer 2 (step S415). An example of the method of reporting the comparison error may be setting the status of the command register 151 at “51h (error)”. The read processor 103 then sets the status of the command register 151 at “50 h (drive ready)” (step S407) to terminate the data read processing. In such a case, it is possible to specify each of the multiplexed data for reading by subsequently issuing the read specification command from the host computer 2.

In this way, since the read processor 103 has the data from all the multiplexedly written locations of recording data, the data comparing unit 105 compares all the data, and the data is transferred to the host computer 2 only when all the data agreed, it is possible to easily detect an error of the multiplexedly written data to improve reliability of the data recorded in the magnetic disk device 1.

Also, when the data is multiplexed by the sector multiplexing, since all the multiplexed data are recorded in the same track, seek of the head in the radial direction of the disk does not occur, and switching the head used for reading data does not occur either. Therefore, in the case of the sector multiplexing, it is possible to reduce the time required for multiplexed write of the data and to avoid delay of data write accompanying multiplexing.

Next, a procedure of processing after a read error occurs during the data read processing is explained. The procedure of processing after a read error occurs can be roughly divided into three cases; (1) when the data is multiplexed; (2) when prohibition of multiplexed read is specified for the multiplexedly written data; and (3) others.

(1) When the data is multiplexed

When the data is multiplexed, the read error occurs in step S411. At this time, since the read processor 103 was reported of a plurality of locations of recording data from the multiplexing manager 104 in step S410, the read processor 103 continues the command of reading the data to other locations of recording data as it is after the read error occurs. The data comparing unit 105 then excludes the data for the location of data read where the read error occurred (step S412), and based on the result, the processings after step S413 are executed. Also, only if all the multiplexed data caused a read error, the read processor 103 reports an uncorrectable error to the host computer 2 to stop the data read processing.

(2) When prohibition of multiplexed read is specified for the multiplexedly written data

When prohibition of multiplexed read is specified for the multiplexedly written data, the read error occurs in step S405. At this time, with reference to the multiplexing controlling table 171, the multiplexing manager 104 again selects a location of recording data other than the location of recording data selected in step S409 from the corresponding multiplexed data, and reports the location of recording data to the read processor 103 as a new location of data read. The read processor 103 then commands the HDC 11 to read the data from the newly reported location of data read. As a result, when the read error occurs to all the locations of recording data stored in the multiplexing controlling table 171, the read processor 103 reports the read error to the host computer 2 to stop the data read processing, but when the data is read in at least one location, the step returns to the processing and the processings in steps S406 and after are executed. In this case, since the data stored in the buffer 13 is only one layer, the comparison of read data is not executed by the data comparing unit 105.

(3) Others

The case applicable to neither (1) nor (2) described above can be when the read data is not multiplexedly written or when the read specification command specifies a read method other than prohibition of multiplexed read, and in either case, the read error occurs in step S405. At this time, since only one location of recording data is reported from the multiplexing manager 104, the read processor 103 again commands the HDC 11 to read the data from the location of recording data to re-execute data read. As a result, when the read processor 103 can read the data correctly, the step returns to the processing and the processings in steps S406 and after are executed. On the other hand, when the read processor 103 cannot read the data correctly even by repeating data read for a specified number of times, the read processor 103 reports the read error to the host computer 2 to stop the data read processing.

Since the read processor 103 does not execute multiplexed read of the data unless the read error occurs and comparison of read data by the data comparing unit 105 is omitted when the read specification command specifies prohibition of multiplexed read, it is possible to reduce the time required for data read while retaining reliability of the data.

According to the present embodiment, the multiplexing manager 104 retains the set up related to multiplexing specified by the host computer 2 and the read/write controller 100 multiplexedly write the data based on the setup, it is possible to change as desired the multiplexed recording method and the degree of multiplexing at the time of multiplexing, and thereby to provide the highly reliable disk device capable of responding to various demands with the inexpensive configuration.

The setups related to multiplexing and read specification retained by the multiplexing manager 104 may be recorded in the system area of the disk drive 20 while the magnetic disk device 1 is shut down, and read from the disk drive 20 at the time of start-up to be stored in the multiplexing manager 104 again. This allows for continuously retain the setups related to multiplexing and read specification specified by the host computer 2 even after the magnetic disk device 1 is shut down.

When a read error occurs during multiplexed read in the data read processing executed by the read/write controller 100, data read from the location where the read error occurred is skipped, but the read/write controller 100 may recover the data that caused the read error. With such a configuration, the data can be recovered by the write processor 102 writing the data of another location of data read that was correctly read and stored in the buffer 13 to the location of data read where the read error occurred.

While the present embodiment explained the magnetic disk device having eight heads and four platters, the present invention is not limited to this but may be similarly applied to a magnetic disk device having only one head. In this case, though the head multiplexing and the platter multiplexing cannot be specified, it is possible to multiplex the data by specifying the cylinder multiplexing or the sector multiplexing. This allows for providing a highly reliable magnetic disk device with less expensive configuration.

Also, while the present embodiment explained the magnetic disk device, the present invention is not limited to this but may be similarly applied to other disk devices such as an optical disk device for CD, DVD, and the like.

According to an embodiment of the present invention, it is possible to change the multiplexed recording method and the degree of multiplexing as desired.

Moreover, it is possible to easily detect an error in the multiplexed data.

Furthermore, it is possible to limit the location of reading even multiplexed and written data to only one location, so that it is possible to have an appropriate data according to the user's decision if there is a data error, and advantageously reduce the time required for reading the data.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A disk device that records data in a disk medium at a plurality of locations in a multiplexed manner, the disk device comprising:
a receiving unit that receives write-method information indicative of a method of multiplexing and degree information indicative of a degree of multiplexing; and
a multiplexed write unit that writes data in the disk medium in a multiplexed manner based on the write-method information and the degree information received by the receiving unit.

2. The disk device according to claim 1, further comprising:
a multiplexed read unit that reads from the disk medium all the data multiplexed and written by the multiplexed write unit, compares all the data, and transfers read data only when all the data is in agreement.

3. The disk device according to claim 2, wherein
the receiving unit receives read-method information indicative of a method of reading the data from the disk medium and location information indicative of a location of data to be read, and
the multiplexed read unit reads data based on the read-method information and the location information.

4. The disk device according to claim 1, wherein the method of multiplexing includes sector multiplexing of writing same data at different locations in one track with one head thereby multiplexing the data.

5. The disk device according to claim 4, wherein the method of multiplexing includes
head multiplexing of writing same data at different locations by using a corresponding heads thereby multiplexing the data,
platter multiplexing of writing same data on a different platter thereby multiplexing the data, and
cylinder multiplexing of writing same data at different location on same cylinder thereby multiplexing the data.

6. The disk device according to claim 1, wherein the multiplexed write unit requests for a next control command at the time of correctly writing the data to one location of data write.

7. A disk control method of controlling a disk medium that records therein data in at a plurality of locations in a multiplexed manner, the disk control method comprising:
receiving write-method information indicative of a method of multiplexing and degree information indicative of a degree of multiplexing; and
writing data in the disk medium in a multiplexed manner based on the write-method information and the degree information received at the receiving.

8. The disk control method according to claim 7, further comprising:
reading from the disk medium all the data multiplexed and written by the multiplexed write unit, compares all the data, and transferring read data only when all the data is in agreement.

9. A command controlling method of issuing a prespecified command to the disk device to control the disk device, the command controlling method comprising:
issuing a write command for writing data on a disk medium of the disk device;
issuing a multiplexing command that includes write-method information indicative of a method of multiplexing and degree information indicative of a degree of multiplexing; and
writing data in the disk medium in a multiplexed manner, when receiving the write command and the multiplexing command, based on the write-method information and the degree information in the multiplexing command.

10. A computer-readable recording medium that stores therein a computer program that causes a computer to implement a command controlling method of issuing a prespecified command to the disk device to control the disk device, the computer program causing the computer to execute:
issuing a write command for writing data on a disk medium of the disk device;
issuing a multiplexing command that includes write-method information indicative of a method of multiplexing and degree information indicative of a degree of multiplexing; and
writing data in the disk medium in a multiplexed manner, when receiving the write command and the multiplexing command, based on the write-method information and the degree information in the multiplexing command.

11. A control circuit that records data in a disk medium at a plurality of locations in a multiplexed manner, control circuit comprising:
a receiving unit that receives write-method information indicative of a method of multiplexing and degree information indicative of a degree of multiplexing; and
a multiplexed write unit that writes data in the disk medium in a multiplexed manner based on the write-method information and the degree information received by the receiving unit.

12. The control circuit according to claim 11, further comprising:
a multiplexed read unit that reads from the disk medium all the data multiplexed and written by the multiplexed write unit, compares all the data, and transfers read data only when all the data is in agreement.

13. The control circuit according to claim 12, wherein
the receiving unit receives read-method information indicative of a method of reading the data from the disk medium and location information indicative of a location of data to be read, and
the multiplexed read unit reads data based on the read-method information and the location information.

14. The control circuit according to claim 11, wherein the method of multiplexing includes sector multiplexing of writing same data at different locations in one track with one head thereby multiplexing the data.

15. The control circuit according to claim 14, wherein the method of multiplexing includes
head multiplexing of writing same data at different locations by using a corresponding heads thereby multiplexing the data,
platter multiplexing of writing same data on a different platter thereby multiplexing the data, and
cylinder multiplexing of writing same data at different location on same cylinder thereby multiplexing the data.

16. The control circuit according to claim 11, wherein the multiplexed write unit requests for a next control command at the time of correctly writing the data to one location of data write.
